(19) United States
(12) Patent Application Publication
(10) Pub. No.: US 2023/0359832 A1
(43) Pub. Date: Nov. 9, 2023

(54) CONTEXT SHARING BETWEEN PHYSICAL AND DIGITAL WORLDS

(71) Applicant: NUANCE COMMUNICATIONS, INC., Burlington, MA (US)

(72) Inventors: Eduardo OLVERA, Phoenix, AZ (US); Abhishek ROHATGI, Quebec (CA); Marco PADRÓN, Montreal (CA); Dinesh SAMTANI, Mississauga (CA)

(73) Assignee: NUANCE COMMUNICATIONS, INC., Burlington, MA (US)

(21) Appl. No.: 17/738,541

(22) Filed: May 6, 2022

(51) Int. Cl. G06F 40/35; G06F 9/451; G06N 5/04; G06F 40/279; G06V 20/50; G06K 19/06

(52) U.S. Cl. CPC G06F 40/35; G06F 9/453; G06N 5/043; G06F 40/279; G06V 20/50; G06K 19/06037

(57) ABSTRACT

There is provided a method that includes (a) obtaining context information that is associated with a physical object, and is related to a context concerning the physical object, (b) searching a database for resultant information, based on the context information, (c) extracting and inferencing intents and entities, from the context information and the resultant information, (d) providing the intents and entities to a virtual assistant, and (e) facilitating a conversation between the virtual assistant and a user.

### BACKGROUND OF THE DISCLOSURE

### 1. Field of the Disclosure

The present disclosure relates to utilization of information that is shared between the physical world and a digital world, for example, in a case where a person is interacting with a virtual assistant.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

A physical world is what we see around us and we experience and interact with the five senses of our bodies, such as a brick-and-mortar store, an article of clothing or a piece of fruit. A digital world is the availability and use of digital tools to communicate on the internet, digital devices, smart devices and other technologies, including things such as emails, text messages, chatbots, virtual assistants, virtual reality, digital assets, etc.

In an omni-channel world, a big challenge is how to carry context around when moving across channels. In particular, a transition from the physical to the digital world is one of the most difficult challenges to address.

Most state-of-the are solutions in the market are siloed in their own channels, so users must start their conversation from scratch every time they shift channels. If context sharing is rarely done in the digital world, in the physical one it is almost non-existing. This causes a lot of frustration from users having to repeat themselves, and errors if the same information isn't properly repeated.

Thus, there is a need for an improved mechanism to bridge the physical and digital worlds, facilitating context sharing.

### SUMMARY OF THE DISCLOSURE

The present document discloses a technique that addresses the above-noted challenge by embedding context into objects in the physical world, via mechanisms such as quick response (QR) codes, geographical location, image recognition or Augmented Reality (AR) mapping, which can then be carried over to digital channels in a type of “warm transfer” so that conversations can continue without having to start from scratch.

There is thus provided a method that includes (a) obtaining context information that is associated with a physical object, and is related to a context concerning the physical object, (b) searching a database for resultant information, based on the context information, (c) extracting and inferencing intents and entities, from the context information and the resultant information, (d) providing the intents and entities to a virtual assistant, and (e) facilitating a conversation between the virtual assistant and a user.

### BRIEF DESCRIPTION OF THE DRAWINGS

FIG. 1 is a block diagram of a system for context sharing between a physical world and a digital world.

FIG. 2 is a block diagram of a process that is performed in a user device in the system of FIG. 1.

FIG. 3 is a block diagram of a process that is performed in a server in the system of FIG. 1.

A component or a feature that is common to more than one drawing is indicated with the same reference number in each of the drawings.

### DESCRIPTION OF THE DISCLOSURE

Conversational context is what allows two or more parties to understand the meaning of their words during an exchange due to the awareness of all aspects of the conversation, which includes details discussed in the present, as well as knowledge and key details that may have taken place in the past. Some common sources of context in human to machine interactions include the user's input (obtained directly), enterprise knowledge (obtained from records), user/task information (obtained from previous interactions and analytics), and session context (obtained from the current session).

The technique disclosed herein leverages physical objects to embed context into them, which can then be passed over or retrieved by a digital channel such as a virtual assistant (VA), hence allowing the context to be preserved, enriched and the conversation to continue, without having to restart the conversation from scratch.

The context is in the form of information embedded in a physical encoding or a digital encoding. Physical encoding is the process of understanding information and converting it into a physical representation for storage in a physical object. Similarly, digital encoding is the process of understanding information and creating a digital representation of it for storage in a digital element.

The technique involves identifying physical objects with which users will be able to interact, and embedding context into the objects. For example, imagine having a shoe at a store and attaching a tag with a QR to it. Then, when the user scans the code, the embedded URL contains a combination of additional elements and values (e.g., store identification (ID), product ID, promotion ID, etc.) that would trigger a virtual assistant experience that would automatically be able to “read” that context and continue the conversation (e.g., greet the user by identifying the store name and location, ask if they have questions about the specific product they scanned, etc.). A similar experience could be triggered by an augmented reality model that can perform image recognition to identify the product and link it to the same set of elements and values, allowing a similar VA conversation to take place.

The context being passed could also be leveraged to proactively retrieve additional product information, such as price details, availability, and even physical location at that particular store, thereby further enriching the original context.

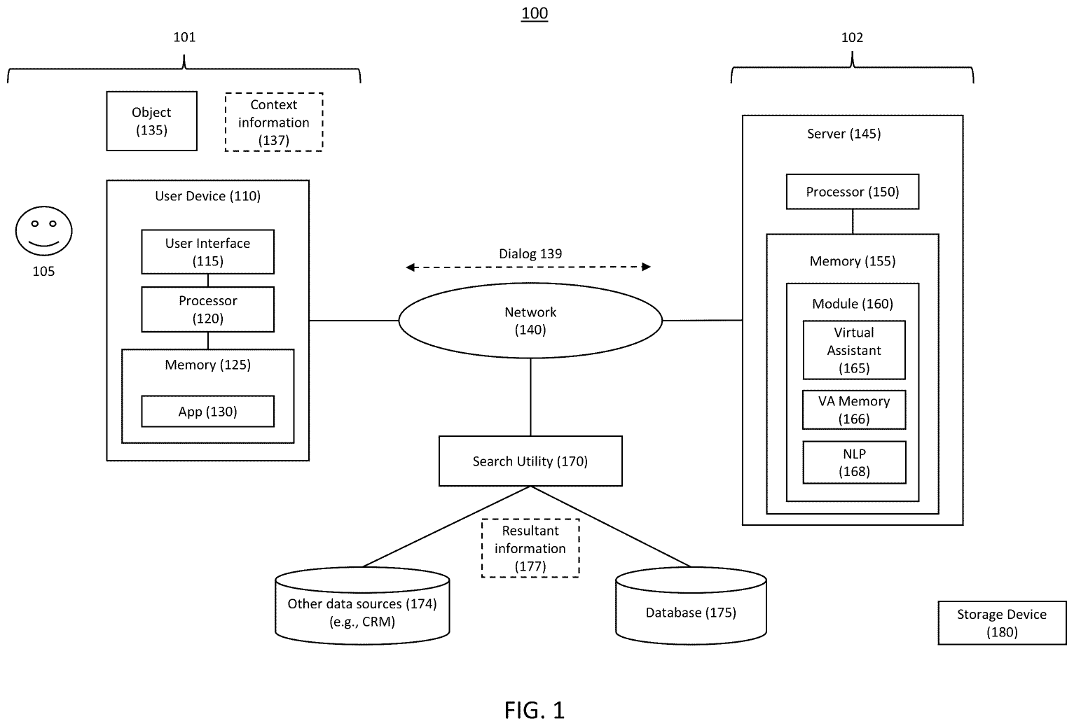

FIG. 1 is a block diagram of a system 100 for context sharing between a physical world 101 and a digital world 102. System 100 includes a user device 110, a server 145 and a search utility 170, which are communicatively coupled to a network 140. A user 105, an object 135 and user device 110 are in physical world 101. Server 145 is in digital world 102.

Network 140 is a data communications network. Network 140 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (0 the Internet, or (g) a telephone network. Communications are conducted via network 140 by way of electronic signals and optical signals that propagate through a wire or optical fiber, or are transmitted and received wirelessly.

User device 110 includes a user interface 115, a processor 120, and a memory 125.

User interface 115 includes an input device, such as a keyboard, speech recognition subsystem, a touch-sensitive screen, or gesture recognition subsystem, that enables user 105 to communicate information to processor 120, and via network 140, to server 145. User interface 115 also includes an output device such as a display or a speech synthesizer and a speaker to provide information to user 105 from processor 120 and server 145.

Processor 120 is an electronic device configured of logic circuitry that responds to and executes instructions.

Memory 125 is a tangible, non-transitory, computer-readable storage device encoded with a computer program. In this regard, memory 125 stores data and instructions, i.e., program code, that are readable and executable by processor 120 for controlling operations of processor 120. Memory 125 may be implemented in a random-access memory (RAM), a hard drive, a read only memory (ROM), or a combination thereof.

One of the components of memory 125 is an application program, namely app 130, which contains instructions for controlling operations of processor 120 in methods described herein.

User device 110 also includes components (not shown) for (a) capturing videos or images, e.g., a camera, (b) determining a geographic location of user device 110, e.g., a global positioning system (GPS) or a near-field communication (NFC) chip, (c) measuring time and temperature, and (c) detecting biometric information about user 105, e.g., biometric sensors. User device 110 may be implemented, for example, as a smart phone, a smart watch, smart glasses, a Virtual Reality (VR) headset, an Internet of Things (IoT) device, a tablet, or a personal computer.

Server 145 is a computer that includes a processor 150 and a memory 155.

Processor 150 is an electronic device configured of logic circuitry that responds to and executes instructions.

Memory 155 is a tangible, non-transitory, computer-readable storage device encoded with a computer program. In this regard, memory 155 stores data and instructions, i.e., program code, that are readable and executable by processor 150 for controlling operations of processor 150. Memory 155 may be implemented in a random-access memory (RAM), a hard drive, a read only memory (ROM), or a combination thereof.

One of the components of memory 155 is a program module, namely module 160, which contains instructions for controlling operations of processor 150 in methods described herein. Module 160 includes a subordinate module designated herein as virtual assistant 165, which utilizes a portion of memory 155 designated as virtual assistant (VA) memory 166.

Virtual assistant 165 is a program that imitates the functions of a personal assistant that engages with user 105 in casual conversations. User 105 interacts with virtual assistant 165 via user device 110, exchanging messages via typed commands, gestures or voice commands.

Module 160 also includes a Natural Language Processor component (NLP) 168 that performs automatic computational processing of human language.

The term “module” is used herein to denote a functional operation that may be embodied either as a stand-alone component or as an integrated configuration of a plurality of subordinate components. Thus, each of app 130 and module 160 may be implemented as a single module or as a plurality of modules that operate in cooperation with one another. Moreover, although app 130 and module 160 are described herein as being installed in memories 125 and 155, respectively, and therefore being implemented in software, each of app 130 and module 160 could be implemented in any of hardware (e.g., electronic circuitry), firmware, software, or a combination thereof.

Additionally, either or both of app 130 and module 160 may be configured on a storage device 180 for subsequent loading into their respective memories 125 and 155. Storage device 180 is a tangible, non-transitory, computer-readable storage device. Examples of storage device 180 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled to user device 110 and server 145 via network 140.

Search utility 170 is a component for searching a database 175 and other data sources 174. Database 175 contains information about a variety of topics. Other data sources 174 are other sources of data, e.g., a customer relationship management (CRM) system.

In operation of system 100, user 105 desires information about object 135. Object 135 has been modified, enhanced, or pre-processed so that it contains context information 137 that user 105 will be able to retrieve from it. Context information 137 is any relevant information regarding the environment, its users and their interaction. For example, a QR code printed on a label on object 135 could store context information 137, or an image of object 135 itself could have been pre-processed by artificial intelligence so that context information 137 could be encoded, therefore allowing user device 110 to capture and store the image in memory 125, and then process it using app 130 to decode the aforementioned context information 137.

User 105 employs user device 110 to engage in a dialog 139, i.e., a conversation, with virtual assistant 165. To facilitate dialog 139, user device 110 obtains context information 137 concerning object 135, and sends context information 137 to server 145. Server 145 uses context information 137 to utilize search utility 170 to obtain resultant information 177 from database 175, and enhances or modifies dialog 139 based on resultant information 177, which could include the original context information 137 embedded in object 135 as well as supplemental and enriched information related to it and obtained from database 175 and other data sources 174.

Some examples of context information 137 for a QR code printed on a label on object 135 could include store information beyond a traditional website address (URL) to include elements such as the store ID or product ID. Similarly, an image of object 135 could be captured by a camera in user device 110 so that any encoded information related to that specific image could be decoded by app 130 as context information 137.

An example of a use of system 100 is a case where user 105 is in a store, and object 135 is a shirt in which user 105 is interested. User 105 employs user device 110 to capture an image of the shirt. User device 110 employs its GPS system to determine the location of user device 110, and thus the location of the store. The image of the shirt and the location are examples of context information 137, which user device 110 sends to server 145. Server 145 uses the image of the shirt and the location to formulate a search, and utilizes search utility 170 to obtain resultant information 177 from database 175. Resultant information 177 may include the brand and model of the shirt identified, its current price, availability, shipping times, current store promotions, a range of prices for the shirt at other stores, the locations of the other stores, information about alternative shirts as well as information about supplemental products or add-on services. Furthermore, based on information from user device 110 and app 130, resultant information 177 could be enhanced by information concerning user 105 from other data sources 174, such as user 105's name, address, customer preferences, recent purchase history and preferred status. User 105 and virtual assistant 165 engage in dialog 139, which virtual assistant 165 enhances or modifies based on resultant information 177.

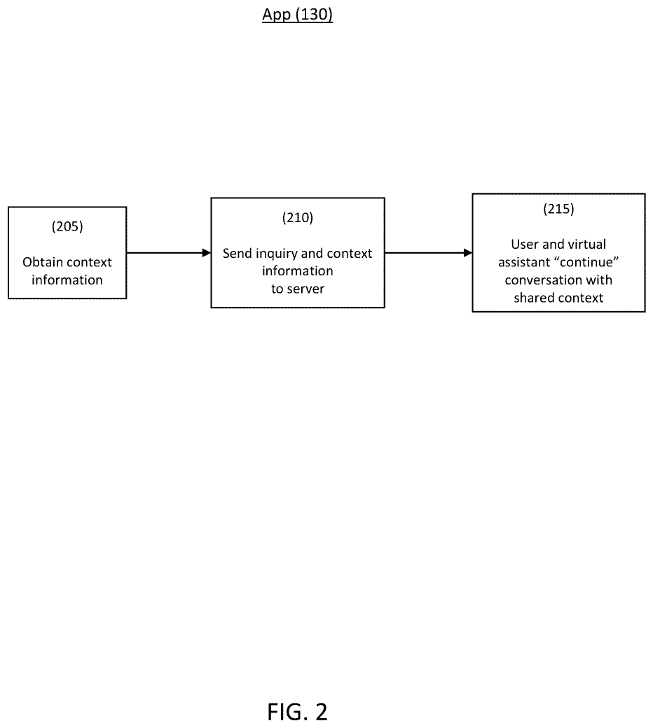

FIG. 2 is a block diagram of app 130, and more specifically, operations performed by processor 120 or other components of user device 110, in accordance with app 130.

Assume, for example, that user 105 is in a store and is interested in a shirt that is offered for sale.

In operation 205, user device 110 obtains context information 137 about object 135. For example, user 105 employs user device 110 to capture an image of a QR code that is affixed to the shirt.

In operation 210, user device 110 sends an inquiry (e.g., a request for assistance), and context information 137 to server 145.

In operation 215, user device 110 facilitates dialog 139 between user 105 and virtual assistant 165. User 105 and virtual assistant 165 can “continue” a conversation that began with the original interaction with object 135 as the original context information 137 combined with resultant information 177 provide the necessary details for a shared context in operation 215, therefore enabling a common ground for conversation between virtual assistant 165 and user 105, hence removing the need to ask user 105 what type of information or help they would need.

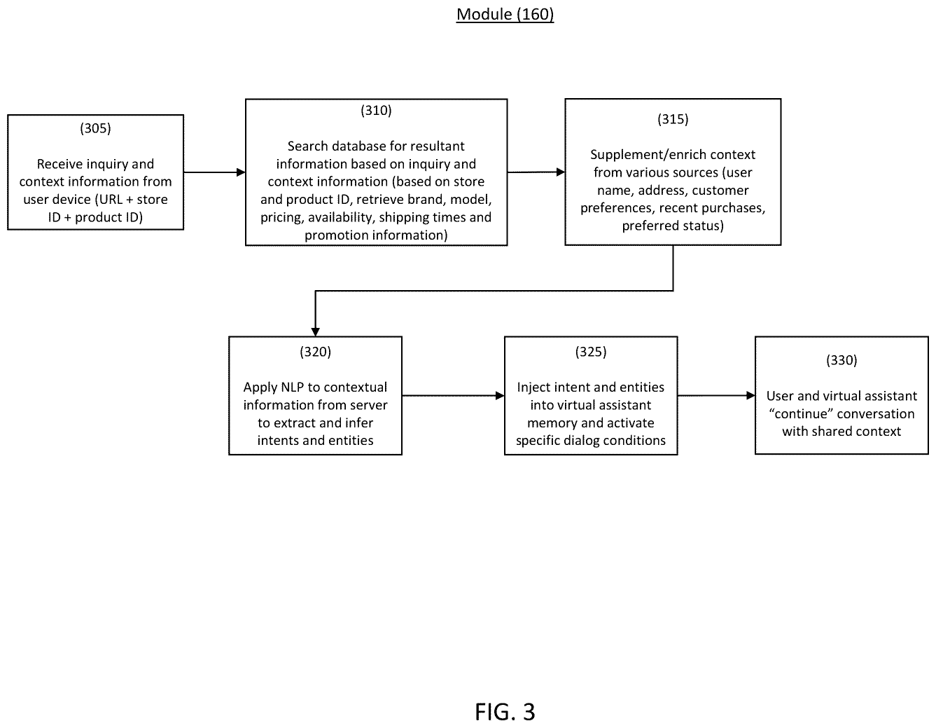

FIG. 3 is a block diagram of module 160, and more specifically, operations performed by processor 150 or other components of server 145 in accordance with module 160 or its subordinate modules, e.g., virtual assistant 165.

Assume, for example, that user 105 is in a store and is interested in a shirt that is being offered for sale, and that user 105 employed user device 110 to capture an image of a QR code that is affixed to the shirt, and user device 110 sent an inquiry and context information to server 145.

In operation 305, server 145 receives the inquiry and context information 137 from user device 110. For example, the inquiry and context information 137 may contain a URL of virtual assistant 165, and additional parameters such as the store ID and product ID.

In operation 310, server 145 utilizes search utility 170 to search database 175, and obtain resultant information 177, such as price details, availability, and even physical location at that particular store, derived from context information 137, directly extracted from user device 110 and forwarded in operation 305.

In operation 315, server 145 utilizes search utility 170 to search other data sources 174, and supplement and enrich resultant information 177 with additional details from other sources, for example, matching user 105 to a profile and retrieving their full name, address, purchase preferences, purchase history, preferred status, etc.

In operation 320, server 145 leverages the information collected, derived and supplemented from operations 310 and 315, and processes it through NLP 168, which extracts and inferences, and thus produces, a set of intents and entities that are stored in VA memory 166.

An intent is the representation of a task or action a user wants to perform. For example, if the user asks, “What's the price for this Hawaiian shirt?”, the user's intent is to learn about the amount of money they would need to pay in exchange for the shirt. Furthermore, a user request might contain additional information elements related to their intent that we might want to extract, often called entities. In the previous example, the additional piece of information related to the type of shirt, i.e., Hawaiian, represents a perfect candidate for an entity that would also be extracted from a user utterance.

As the conversation between user 105 and virtual assistant 165 evolves, NLP 168 evaluates each turn in dialog 139, analyzing user 105's request and extracting the relevant intents and entities in operation 320.

In operation 325, server 145 uses the set of intents and entities generated by NLP 168, and injects them into virtual assistant 165's memory, i.e., VA memory 166, which in return triggers specific conditions in virtual assistant 165's conversational dialog path, and thus activates dialog conditions of virtual assistant 165 that are used to produce output messages that take the conversational context into consideration. For example, if user 105 first asked about the price of the shirt and then asks if there are any discounts available, the new request would return a new intent related to promotions. The new intent would trigger a condition in virtual assistant 165 so that it would move away from a pricing path, and switch the flow of the dialog to a promotions path where it would retrieve available discount information and present it to user 105.

In operation 330, server 145 facilitates a “continuation” of dialog 139 between user 105 and virtual assistant 165, based on resultant information 177 and NLP 168's intents and entities generated in operation 320 and injected into VA memory 166 in operation 325. For example, if after asking about pricing information user 105 then asks, “and in what sizes does it come”, NLP 168 would identify that user 105 is asking about size availability but is not yet able to identify the object to which user 105 is referring. But when that information is combined with resultant information 177, which included available product information, virtual assistant 165 is then able to infer that user 105 is talking about the same object 135 they scanned or looked at, and can continue the conversation as it now has a shared context with user 105.

User device 110 could include additional capabilities such as augmented reality features that would allow dialog 139 to take place in real time by overlaying resultant information 177 directly on top of object 135 being looked at through user interface 115.

Thus, system 100 performs a method that includes:
a. embedding, by a physical encoding (e.g., a QR code) or digital encoding (e.g., an image identification pre-processing), contextual information related to a physical object and its context;
b. extracting, by a server, the encoded contextual information from the physical object;
c. searching, from a database, resultant information connected to the information encoded in the physical object;
d. supplementing and enriching, by a search utility connected to additional information sources, the contextual information originally retrieved from the physical object;
e. extracting and inferencing intents and entities, by a natural language processor, from the contextual information collected, retrieved and enriched throughout the process; and
f. injecting, by a server, the intents and entities into a virtual assistant's memory and activating specific dialog conditions to facilitate the continuation of a conversation with a user with shared context.

System 100 is particularly relevant for organizations that have both physical and digital channels, such as retail, travel or healthcare, so that products in their physical space can be imbued with context that can then be leveraged by their digital channels, such as mobile virtual assistants.

The techniques described herein are exemplary, and should not be construed as implying any particular limitation on the present disclosure. It should be understood that various alternatives, combinations and modifications could be devised by those skilled in the art. For example, operations associated with the processes described herein can be performed in any order, unless otherwise specified or dictated by the operations themselves. The present disclosure is intended to embrace all such alternatives, modifications and variances that fall within the scope of the appended claims.

The terms “comprises” or “comprising” are to be interpreted as specifying the presence of the stated features, integers, operations or components, but not precluding the presence of one or more other features, integers, operations or components or groups thereof. The terms “a” and “an” are indefinite articles, and as such, do not preclude embodiments having pluralities of articles.

What is claimed is:

1. A method comprising:
obtaining context information that is associated with a physical object, and is related to a context concerning said physical object;
searching a database for resultant information, based on said context information;
extracting and inferencing intents and entities, from said context information and said resultant information;
providing said intents and entities to a virtual assistant; and
facilitating a conversation between said virtual assistant and a user.

2. The method of claim 1, wherein said context information is embedded in a physical encoding.

3. The method of claim 2, wherein said obtaining comprises extracting said context information from said physical encoding.

4. The method of claim 2, wherein said physical encoding is embodied in a quick response (QR) code.

5. The method of claim 1, wherein said context information is embedded in a digital encoding.

6. The method of claim 1, wherein said obtaining comprises extracting said context information from said digital encoding.

7. The method of claim 6, wherein said digital encoding is produced through an image identification pre-processing of said physical object.

8. The method of claim 1, further comprising:
obtaining additional information from a data source; and
supplementing said resultant information with said additional information.

9. The method of claim 8, wherein said additional information comprises information concerning said user.

10. The method of claim 1, wherein said extracting and inferencing is performed by a natural language processing component.

11. The method of claim 1, wherein said facilitating comprises activating a dialog condition of said virtual assistant.

12. The method of claim 11, wherein said activating said dialog condition facilitates a continuation of said conversation.

13. A system comprising:
a processor; and
a memory that contains instructions that are readable by said processor to cause said processor to perform the method of claim 1.

14. A non-transitory storage device comprising instructions that are readable by a processor to cause said processor to perform the method of claim 1.
